(19) United States
(12) Patent Application Publication
(10) Pub. No.: US 2005/0218360 A1
(43) Pub. Date: Oct. 6, 2005

(54) Choke valve

(76) Inventors: David Eric Appleford, Essex (GB); Brian William Lane, Essex (GB)

Correspondence Address: SUMMA & ALLAN, P.A., 11610 NORTH COMMUNITY HOUSE ROAD, SUITE 200, CHARLOTTE, NC, 28277, US

(21) Appl. No.: 10/513,097

(22) PCT Filed: Apr. 30, 2003
(86) PCT No.: PCT/GB03/01850

§ 371 Date: May 20, 2005

(30) Foreign Application Priority Data
May 1, 2002 (GB) 0209986.9

(51) Int. Cl. F16K 47/00

(52) U.S. Cl. 251/118; 251/902

(57) ABSTRACT

A valve (2) has a body (4) defining a flow inlet (6), a flow outlet (8) and a valve chamber (10). A compression coil spring (24) is contained within the chamber (10) and its coils (32) divide the inlet (6) from the outlet (8). One end of the spring (24) is seated against a reaction block (20) and an actuating rod (16) extending into the valve chamber (10) bears on the block enabling it to be lowered or raised. This action causes the size of the helical gaps (34) between the coils (32) of the spring to be altered which adjusts the flow of fluid through the valve.

The present invention relates to choke valves used for the control of pressure and/or flow rates in systems such as hydrocarbon production systems.

Typically, in hydrocarbon production systems in which a number of separate flows at different pressures feed into a common manifold, a choke valve is incorporated in each flow to optimise the total flow at some common pressure. Some choke valves are configured with a fixed orifice area and can only be changed by substituting a different sized orifice. Other choke valves are arranged with adjustable orifices. A common configuration is for the flow to be arranged to pass from an inlet port of the choke valve into an annular chamber, so that equal pressure is available at diametrically opposed circular orifices located in an inner wall of the chamber. A plain cylindrical annular control sleeve is arranged to uncover these orifices to a greater or lesser extent thereby providing the control parameter. Pressure is dissipated within a central chamber of the valve by allowing these diametrically opposite flows to impinge upon each other thereby absorbing energy. The more the fluid flows collide, the more energy is absorbed. After collision, the fluid flows turn through 90° and are discharged from the valve.

A disadvantage of this arrangement is that for the linear distance moved by the control sleeve, a variable orifice area is uncovered or covered, which gives a non-linear change in the control parameter. Another disadvantageous feature, is that at very small orifice openings, and with a high pressure drop across the orifices, very high erosion wear results from the high velocity jets of production fluids generated under these conditions. This concentrated wear takes the form of grooves worn in walls defining the orifices and in end regions of the control sleeve which move over the orifices. This phenomenon is commonly referred to as wire drawing. When the fluid contains abrasive particles, e.g. sand, erosion will occur particularly rapidly. When operating in the nearly closed part of the valve envelope, this erosion wear changes the characteristics of the valve such that early replacement is necessary, and/or costly trim components for the valve are required to extend its life. Furthermore, the end region of the sleeve, which moves over the orifices, may be designed to seal against an annular valve seat when the valve is fully closed. Such sealing may become impossible when the erosion described above has occurred and the valve may lose its isolating capability.

The object of the invention is to overcome at least some of the above-mentioned problems of the prior art adjustable choke valves.

Thus, according to the invention, there is provided a valve comprising a choke means defining at least one passageway and control means for adjusting the size of the at least one passageway to adjustably choke a flow of fluid through the valve wherein the choke means includes spring means with parts between which the at least one passageway is situated whereby deformation of the spring means by the control means alter the size of the at least one passageway for adjusting the flow of fluid through the valve.

By providing the passageways between parts of a spring means, localised erosion as discussed above can be avoided since at least one passageway can be configured to comprise one or more extended passageways which spread out the areas of the valve components exposed to wear and thereby avoids localised erosion. A more linear relationship between volumetric flow rate through the valve and movement of the control means can also be achieved.

In order to slow the fluid passing through the valve and absorb its energy, preferably the spring means is configured such that at least one passageway includes confronting parts which act to direct parts of the fluid flow against each other to dissipate flow energy.

Conveniently the spring means is substantially cylindrical and the flow of fluid passes between a region inside and a region outside the spring means as it passes through the valve.

So as to reduce the chance of the valve being clogged as it approaches its fully closed state and when used with fluid containing particles, preferably the spring means has different stiffnesses at different points along its length such that choking of the fluid flow through the at least one passageway occurs at different rates along its length as the control means is adjusted. With such an arrangement, if for example the spring means comprises an array of passageways between individual spring elements, then the stiffness of the elements can be graded or at least be different so that closure of the passageways occurs progressively as the valve is closed. In this way, immediately prior to complete closure, one relatively large passageway can remain open as opposed to a plurality of relatively smaller ones. This larger passageway will permit larger particles to pass through the valve without becoming lodged therein.

In order to minimise the number of components in the valve and when flow velocities are not likely to cause unwanted resonant vibrations or harmonics in the spring means, it may comprise a coil spring, the at least one passageway being defined between coils thereof and the control means being arranged to vary an axial length thereof. With such an arrangement, the passageway may comprise a single helical passageway defined between the coils of the spring.

So as to enable the valve to dissipate more energy from fluid flowing through the valve, the spring means may comprise plural coil springs substantially concentrically disposed in order that fluid passing through the spring means successively passes through two or more sets of coils.

When the flow through the valve is sufficiently high that resonant vibration of the spring means is likely to be a problem and/or if there is a requirement for the stiffness to be different in different parts of the spring means, the spring means preferably comprises a plurality of discrete spring elements arranged to bear directly or indirectly on each other.

Preferably at least some of the spring elements each include plural apertures through which the fluid flows in order to dissipate energy from fluid flowing through the valve. More preferably, at least some of the apertures of adjacent spring elements substantially confront each other so that fluid flows passing through such confronting apertures impinge on each other to dissipate still more flow energy.

Conveniently the spring elements are spring washers such as Belville washers.

In order to hold the spring elements in place relative to each other and further components of the valve, the spring means preferably includes annular locating rings interposed between adjacent spring washers.

In order to increase the amount of energy dissipated by fluid flowing through the valve, preferably adjacent locating rings include complementary confronting surfaces which define one of said at least one passageway.

The locating means may be configured to direct or otherwise control the flow path of fluid passing through the valve. For example, the spring washers may be disposed in an axial array with a central longitudinal axis and the confronting surfaces of the locating rings may be disposed at an oblique angle to the longitudinal axis. The oblique angle may be between 20° and 70° and the flow may be directed away from the direction in which the flow passes when leaving the valve.

One or both of the radially inner or outer peripheries of the spring washers may have a set of locating rings interposed therebetween including said complementary surfaces. When two sets of locating rings are provided, both including said complementary surfaces, a high level of flow energy dissipation will be achieved.

When less energy dissipation is required, the locating rings between one of the inner or outer peripheries of the spring washers may merely act to hold the spring washers in position relative to each other. In order to increase the range of applications in which the valve can be used, preferably full compression of the spring means by the control means acts to at least substantially close the at least one passageway to thereby at least substantially prevent flow through the valve.

The invention will now be described by way of example only with reference to the accompanying schematic drawings in which:

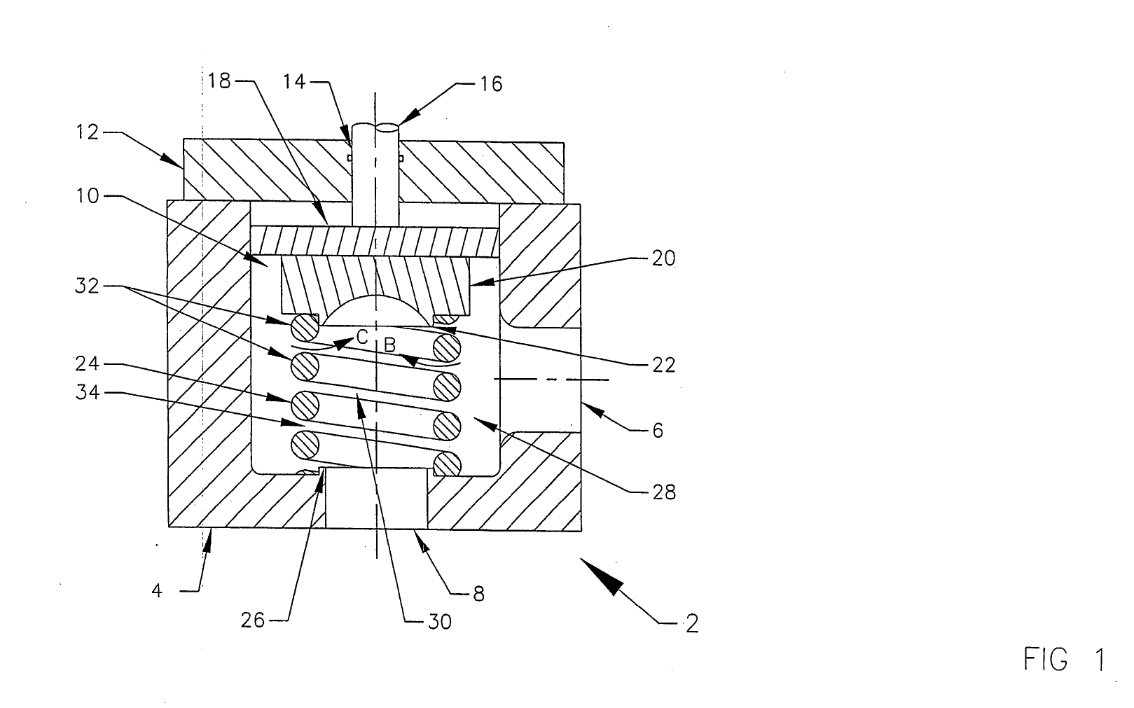

FIG. 1 is a cross-section of a first embodiment of the invention;

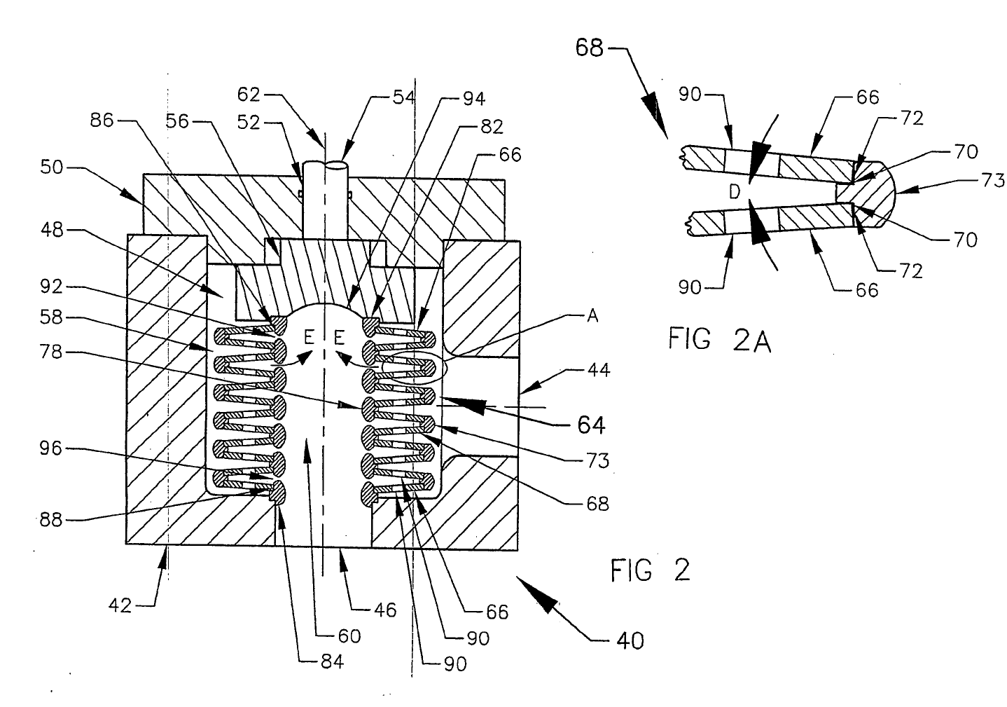

FIG. 2 is a cross-section of a second embodiment of the invention in an opened state;

FIG. 2A is an enlarged view of the area marked A in FIG. 2;

FIG. 3 is a cross-section of the second embodiment of the invention in a closed state;

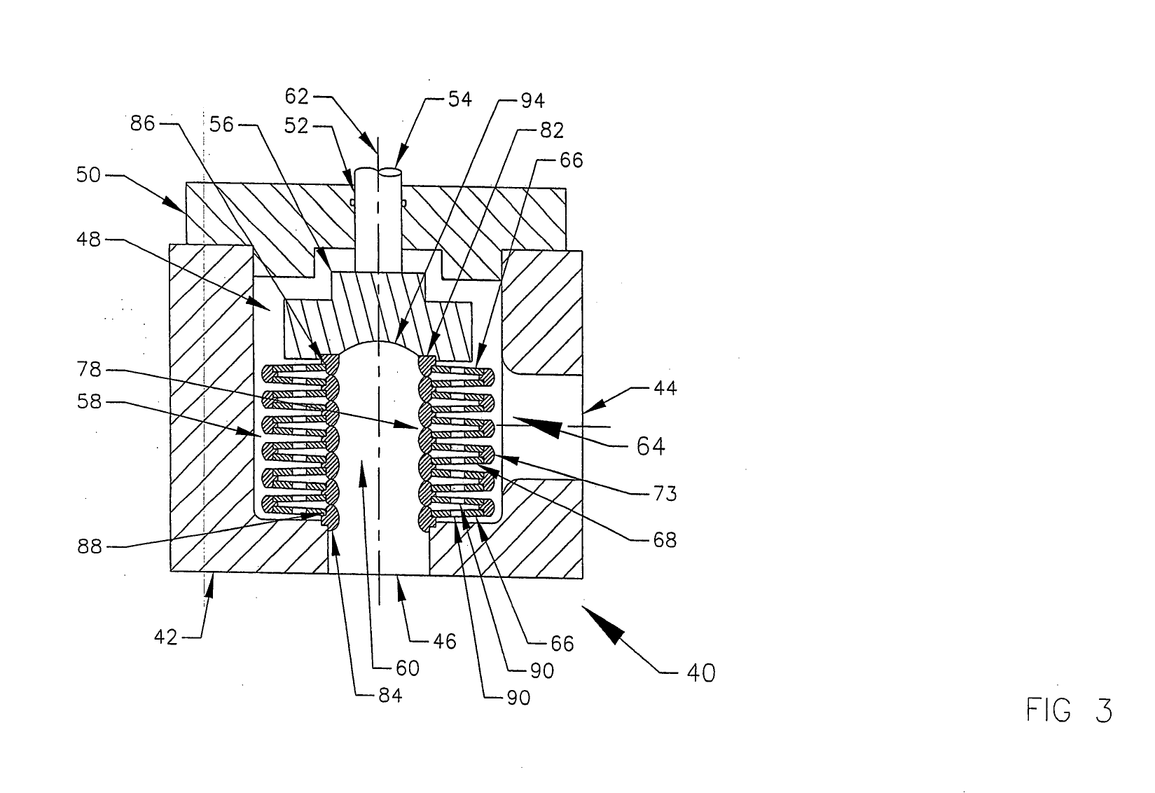

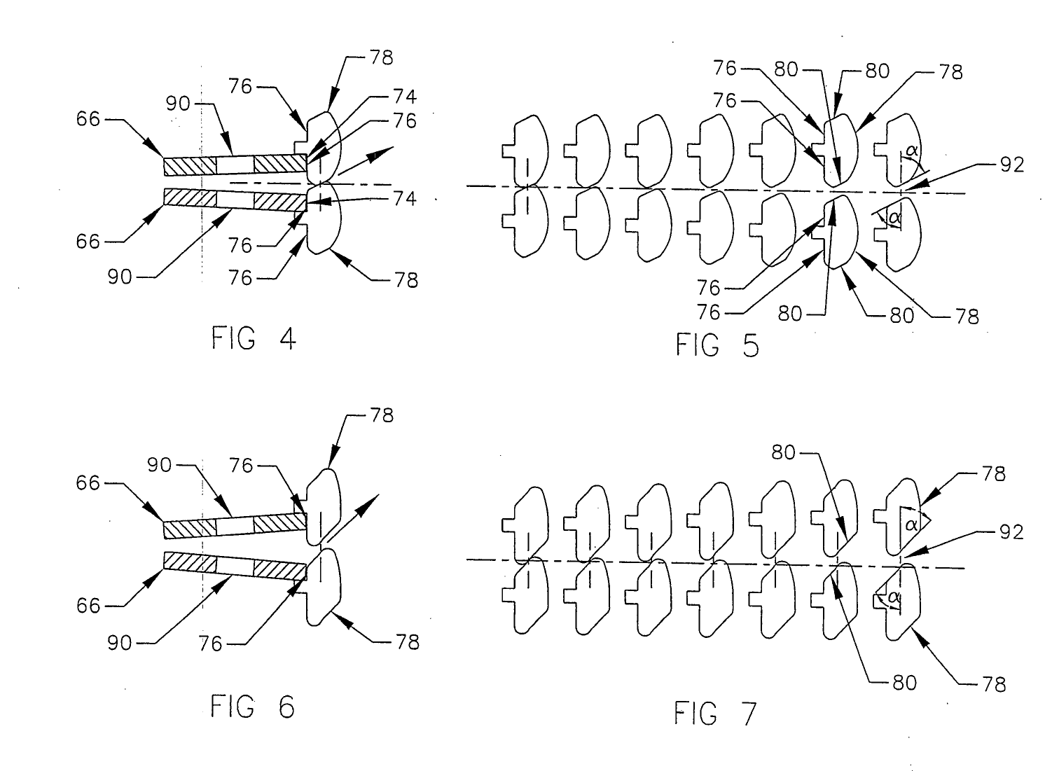

FIG. 4 is a cross-sectional detail showing an interface between two adjacent locating rings of the second embodiment;

FIG. 5 shows a series of views of two confronting surfaces of the locating rings of FIG. 4 as they move relative to each other;

FIG. 6 is a cross-sectional detail showing an alternative interface between the locating rings of the second embodiment;

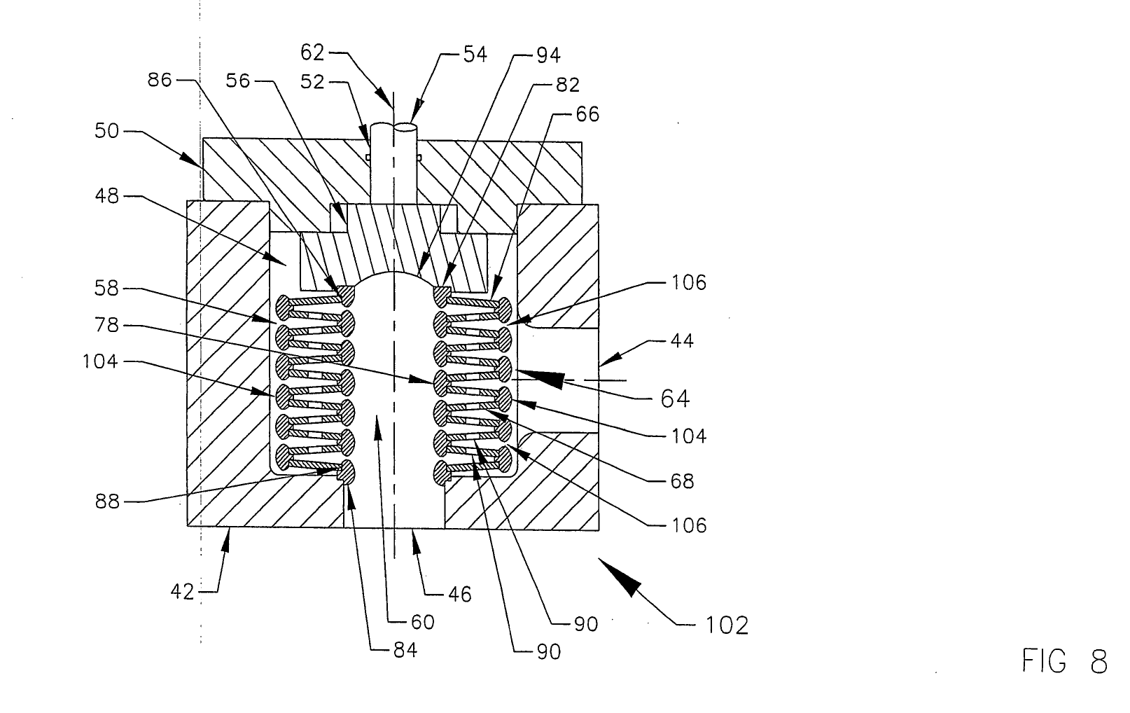

FIG. 7 shows a series of views of two confronting surfaces of the locating rings of FIG. 6 as they move relative to each other;

FIG. 8 is a cross-section of a third embodiment of the invention in an open state; and

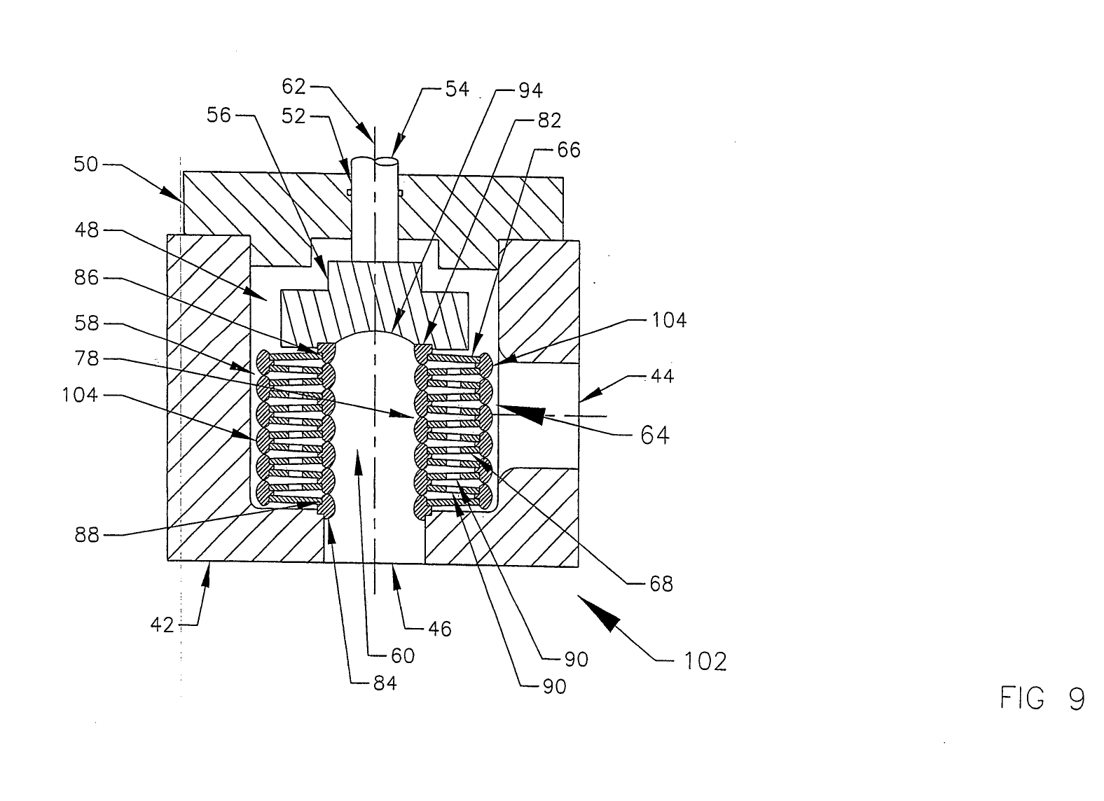

FIG. 9 is a cross-section of the third embodiment in a closed state.

FIG. 1 shows a valve 2 constituting the first embodiment of the invention which includes a body 4 defining an inlet 6, an outlet 8 and a valve chamber 10. A cover 12 closes an upper end of the chamber 10 and has a through bore 14 which slidably receives an actuating rod 16 with a head 18 on its lower end. The head 18 bears on the upper end of a reaction block 20, the lower end of which has a downwardly projecting annular rim 22 against which one end of a compression coil spring 24 is seated. The coil spring 24 is formed from a helically configured member of circular cross section. The lower end of the coil spring 24 is seated around an annular rim 26 of the valve body 4 which projects into the valve chamber 10 away from the outlet 8. An exterior region 28 of the valve chamber 10 and the inlet 6 are divided from an interior region 30 of the valve chamber 10 and the outlet 8 by the coils 32 of the coil spring 24 when the head 18 has been fully lowered by the actuating rod 16 so that circumferential surfaces of individual coils 32 of the spring 24 are forced into contact with each other. For complete closure of the valve, it is necessary for the ends of the spring to seal against the rims 22 and 26.

The valve is opened by raising the reaction block 20 by means of the actuating rod 16 so that the spring 24 is progressively released and a helical gap or passageway 34 opens up between the coils 32 of the spring. Fluid entering the valve through the inlet 6 can then pass from the exterior region 28 to the interior region 30 of the valve chamber 10 by passing inwardly through the gap 34 between the coils of the spring 24 as shown at B and C. Flow energy of the fluid is dissipated as this occurs.

Due to the fact that flow into the interior region 30 is all substantially radially inwardly directed, substantially confronting portions of the gap 34 will provide flows which will impinge against each other (as indicated by arrows B and C) thus dissipating energy. Fluid in the interior region 30 can leave the valve via the outlet 8.

Spring erosion resulting from fluid, possibly containing abrasive particles, passing through the gap 34, occurs evenly along the length of the gap 34 and localised high erosion rates are avoided. Furthermore, the relationship between the flow rate and displacement of control means, in the form of the actuating rod 16, will be much closer to a linear relationship than for the conventional type of valve referred to above.

The parts which act to control flow through the valve are conveniently formed as one element and the sliding of surfaces of such parts against each other can be avoided. The relatively long length and relatively short width of the gap 34 assists in dissipating flow energy and the length of the gap 34 can be easily altered by employing a spring having more or less coils. The cross-sectional shape of the wire of the spring can be varied to optimise flow conditions. The velocity gradient of the flow is less steep than for a sharp-edged orifice which leads to less turbulence and quieter operation for a given flow rate.

A cascaded flow path can be provided by utilising plural springs nested within one another, possibly with the helixes of circumferentially adjacent springs being disposed in opposite directions.

Although a compression spring is referred to a similar effect could be achieved with a tension spring.

The second embodiment of the invention is shown in FIG. 2. The valve 40 includes a body 42 with an inlet 44, an outlet 46 and a valve chamber 48 closed by a cover 50 having a through bore 52 which slidingly receives an actuating rod 54 which projects into the chamber 48 where it is connected to a reaction block 56.

Concentrically disposed with respect to a central axis 62 of the outlet 46 is a stack 64 of spring washers 66 (such as Belville washers) which tend to spring back to a non-flat configuration as shown in FIG. 2 when flattened. As shown in FIG. 2A, which is an enlarged detail of region A of FIG. 2, the stack 64 comprises pairs 68 of spring washers 66 with their adjacent outer peripheries 70 located in annular recesses 72 of annular outer locating rings 73.

The inner peripheries 74 of adjacent spring washers 66 of adjacent pairs 68 thereof, as shown in detail in FIG. 4, are located in externally facing annular recesses 76 in annular inner locating rings 78. FIG. 5 shows a series of cross-sectional views of adjacent parts of two of these inner locating rings 78 as they move into contact with each other and separate. Confronting surfaces 80 of the locating ring 78 are disposed at an angle α to the direction of the central axis 62. In the inner locating rings 78 shown in FIGS. 4 and 5, this angle α is 60°.

The uppermost and lowermost spring washers of the stack 64 (as viewed in FIG. 3) have their inner peripheries engaged in a recess in modified locating rings. The uppermost locating ring 82 is sealed in a recess 86 in a lower surface of the reaction block 56 and the lowermost locating ring 84 is sealed in a recess 88 in the body 42 of the outlet 46.

Each spring washer 66 has plural perforations 90 (two per washer shown in FIG. 2), between its inner 74 and outer 70 peripheries. The perforations 90 of each pair 68 of spring washers are aligned with each other.

When the reaction block 56 is lowered so as to fully compress the stack 64 of spring washers 66, as shown in FIG. 3, the confronting surfaces 80 of the inner locating rings 78 are forced into sealing contact with each other and flow between exterior 58 and interior 60 regions of the valve chamber situated respectively outside and inside the stack 64, is prevented.

As downward force on the actuating rod 54 is released, the reaction block 56 is forced upwardly by resilience of the stack of spring washers 66 and passageways 92 open up between the confronting surfaces 80 of the locating rings 78. This permits fluid to enter the inlet 44 and pass through the perforations 90. Each flow through a perforation 90 will collide with a complementary flow through a confronting perforation 90, as shown at D in FIG. 2A. The flows will then pass through the passageways 92 and be directed at the angle α to the central axis 62 inwardly and upwardly towards a concave lower surface 94 of the reaction block 56. Flows from diametrically opposed portions of each passageway 92 will collide with each other as shown at. E, thereby dissipating. further energy and the flows will then be diverted towards the outlet 46 and leave the valve.

Depending on the flow velocities, dimensions, energy absorbing requirements etc. the angle α may be other than 60° and could for example be 30° as shown in FIGS. 6 and 7 in which parts which correspond to those shown in FIGS. 4 and 5 are designated with like numerals and are accordingly not described. below.

In order to provide progressive opening and closing of the passageways 92, the spring washers 66 may have graded stiffnesses. For example, if the stiffness of the spring washers 66 increases towards the bottom of the stack, then the lowermost passageway 96 will be the first to open and the uppermost passageway will be the last to open. Conversely, the lowermost passageway will be the last to close. Accordingly, immediately prior to complete closure of the valve, a single relatively wide passageway 96 will remain open. In contrast, if all spring washers have the same stiffness then plural relatively narrow passageways will be left open leading to a higher chance of particles becoming trapped therein. Other stiffness variations are possible. Stiffer washers could be located at the middle of the stack 64 or a single stiffer spring washer or pair of spring washers could be included.

FIGS. 8 and 9 show a third embodiment of the invention. Parts which correspond to those shown in FIGS. 2-5 are designated by the same numerals and are not described below.

The valve 102 shown in FIGS. 8 and 9 differs from that shown in FIGS. 1 and 2 in that its outer locating rings 104 are configured similarly to the inner locating rings 78 of the FIG. 2 embodiment in that they include confronting surfaces which seal against, or at least come close to each other, when the reaction block is fully lowered so that the inner locating rings 78 seal against each other. As a consequence, further dissipation of flow energy will occur as the flow passes inwardly through the passageways 106 between the outer locating rings 104.

The uppermost and lowermost spring washers (i.e. those at opposite ends of the stack 64) do not contain perforations 90. This is so that all fluid entering the interior region 60 of the stack 64 is constrained to pass through a throttling passageway between two adjacent outer locating rings in addition to passing through a throttling passageway 92 between the-adjacent inner locating rings.

FIG. 8 shows the valve 102 in its open state with the stack 64 uncompressed, and FIG. 9 shows the valve 102 in its closed state with the stack 64 completely compressed.

The spring washers 66 in the embodiment shown in FIG. 8 may have different stiffnesses, passageway orientations etc. as described above with reference to the FIG. 2 embodiment.

As with the coil spring embodiment of FIG. 2, the overall maximum passageway area can be easily modified by employing more or less spring washers.

Since the locating rings are easily manufactured discrete annular parts, they can be manufactured with properties suiting particular erosion, cavitation, sealing etc. requirements independent of the properties of the spring washers.

1. A valve (40) comprising a choke means defining at least one passageway (92) and control means (54, 56) for adjusting the size of the at least one passageway to adjustably choke a flow of fluid through the valve wherein the choke means includes spring means (64) with parts between which the at least one passageway is situated whereby deformation of the spring means (64) by the control means alter the size of the at least one passageway for adjusting the flow of fluid through the valve, characterized in that the spring means comprises a plurality of discrete spring elements (66) arranged to bear directly or indirectly on each other.

2. The valve as claimed in claim 1, wherein the spring means (64) is configured such that the at least one passageway (92) includes confronting parts which act to direct parts of the fluid flow against each other to dissipate flow energy.

3. The valve as claimed in claim 1, wherein the spring means (64) is substantially cylindrical and the flow of fluid passes between a region (58) outside and a region (60) inside the spring means as it passes through the valve (40).

4. The valve as claimed in claim 1, wherein the spring means (64) has different stiffnesses at different points along its length such that choking of the fluid flow through the at least one passageway occurs at different rates along its length as the control means (54, 56) is adjusted.

5. The valve as claimed in claim 1, wherein at least some of the spring elements (66) each include plural apertures (90) though which the fluid flows.

6. The valve as claimed in claim 5, wherein at least some of the apertures (90) of adjacent spring elements (66) substantially confront each other.

7. The valve as claimed in claim 1, wherein the spring elements comprise spring washers (66).

8. The valve as claimed in claim 7, wherein the spring means (64) includes annular locating rings (78) interposed between adjacent spring washers (66).

9. The valve as claimed in claim 8, wherein the adjacent locating rings (78) include complementary confronting surfaces (80) which define one of said at least one passageway.

10. The valve as claimed in claim 9, wherein the spring washers (66) are disposed in an axial array with a central longitudinal axis (62) and the confronting surfaces (80) of the locating rings (78) are disposed at an oblique angle to the longitudinal axis.

11. The valve as claimed in claim 10, wherein the oblique angle is between 20° and 70°.

12. The valve as claimed in claim 10, wherein the spring washers which are at opposite ends of the axial array are free of apertures.

13. The valve as claimed in claim 9, wherein radially inner or outer peripheries of the spring washers (66) have a first set of locating rings (78) interposed therebetween including said complementary confronting surfaces (80).

14. The valve as claimed in claim 13, wherein the other of the radially inner or outer peripheries of the spring washers (66) have a second set of locating rings (104) interposed therebetween including said complementary confronting surfaces.

15. The valve as claimed in claim 13, wherein the other of the radially inner or outer peripheries of the spring washers have locating rings (73) therebetween which merely act to hold the spring washers in position relative to each other.

16. The valve as claimed in claim 1, wherein full compression of the springs means (64) by the control means (54, 56) acts to at least substantially close the at least one passageway (92) to thereby at least substantially prevent flow through the valve (40).

17. (canceled)

18. (canceled)

19. (canceled)
